(19) United States
(12) Patent Application Publication
(10) Pub. No.: US 2025/0162082 A1
(43) Pub. Date: May 22, 2025

(54) LASER PROCESSING METHOD, LASER PROCESSING APPARATUS, AND ELECTRONIC DEVICE MANUFACTURING METHOD

(71) Applicant: Gigaphoton Inc., Tochigi (JP)

(72) Inventors: Yasufumi KAWASUJI, Oyama-shi (JP); Osamu WAKABAYASHI, Oyama-shi (JP)

(73) Assignee: Gigaphoton Inc., Tochigi (JP)

(21) Appl. No.: 19/007,977

(22) Filed: Jan. 2, 2025

Related U.S. Application Data
(63) Continuation of application No. PCT/JP2022/030505, filed on Aug. 9, 2022.

(51) Int. Cl. B23K 26/38; B23K 26/06; B23K 26/14; B23K 101/42; B23K 103/00

(52) U.S. Cl. CPC B23K 26/38; B23K 26/0643; B23K 26/14; B23K 2101/42; B23K 2103/54

(57) ABSTRACT

A laser processing method according to one aspect of the present disclosure includes depositing a product generated from a first glass substrate at a processing position of a second glass substrate by irradiating the first glass substrate with a first ultraviolet pulse laser beam under a first irradiation condition, and forming a hole by irradiating the processing position where the product is deposited with a second ultraviolet pulse laser beam under a second irradiation condition different from the first irradiation condition.

### CROSS-REFERENCE TO RELATED APPLICATIONS

The present application is a continuation application of International Application No. PCT/JP2022/030505, filed on Aug. 9, 2022, the entire contents of which are hereby incorporated by reference.

### BACKGROUND

### 1. Technical Field

The present disclosure relates to a laser processing method, a laser processing apparatus and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248.0 nm and an ArF excimer laser apparatus that outputs a laser beam having a wavelength of about 193.4 nm are used.

Since an excimer laser beam has a pulse width of about several 10 ns and a wavelength is as short as 248.4 nm and 193.4 nm, respectively, an excimer laser beam is sometimes used for direct processing of a polymer material and a glass material or the like.

Chemical bonds in a polymer material can be cut by an excimer laser beam having higher photon energy than bonding energy. Therefore, it is known that an excimer laser beam can be used for non-heating processing of a polymer material, which leads to a high-quality processing shape.

In addition, glass and ceramics or the like have a high absorptance to an excimer laser beam so that it is known that even a material that is difficult to be processed by visible and infrared laser beams can be processed by an excimer laser beam.

Spectral linewidths of spontaneous oscillation beams of the KrF excimer laser apparatus and the ArF excimer laser apparatus are as wide as from 350 μm to 400 μm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: U.S. Patent Application Publication No. 2020/0209760
Patent Document 2: U.S. Patent Application Publication No. 2022/0050382
Patent Document 3: U.S. Patent Application Publication No. 2017/0096361
Patent Document 4: U.S. Patent Application Publication No. 2019/0359515
Patent Document 5: U.S. Patent Application Publication No. 2004/0013951
Patent Document 6: International Publication No. 2022/079798

### SUMMARY

A laser processing method according to one aspect of the present disclosure includes depositing a product generated from a first glass substrate at a processing position of a second glass substrate by irradiating the first glass substrate with a first ultraviolet pulse laser beam under a first irradiation condition, and forming a hole by irradiating the processing position where the product is deposited with a second ultraviolet pulse laser beam under a second irradiation condition different from the first irradiation condition.

A laser processing apparatus according to one aspect of the present disclosure includes an optical device and a laser processing processor. The optical device is configured to irradiate a first glass substrate and a second glass substrate with an ultraviolet pulse laser beam output from a laser apparatus. The laser processing processor is configured to control the laser apparatus and the optical device. The laser processing processor causes a product generated from the first glass substrate to be deposited at a processing position of the second glass substrate by irradiating the first glass substrate with the ultraviolet pulse laser beam under a first irradiation condition, and causes the processing position where the product is deposited to be irradiated with the ultraviolet pulse laser beam under a second irradiation condition different from the first irradiation condition.

An electronic device manufacturing method according to one aspect of the present disclosure includes depositing a product generated from a first glass substrate at a processing position of a second glass substrate by irradiating the first glass substrate with a first ultraviolet pulse laser beam under a first irradiation condition, forming a through-hole by irradiating the processing position where the product is deposited with a second ultraviolet pulse laser beam under a second irradiation condition different from the first irradiation condition, coupling and electrically connecting an interposer including the second glass substrate and a conductor provided in the through-hole and an integrated circuit chip with each other, and coupling and electrically connecting the interposer and a circuit board with each other.

### BRIEF DESCRIPTION OF THE DRAWINGS

Some embodiments of the present disclosure will be described below, by way of example only, with reference to the accompanying drawings.

FIG. 1 is a SEM image illustrating a porous product deposited by irradiating an alkali-free glass substrate with an ultraviolet pulse laser beam.

FIG. 2 is a diagram schematically illustrating a configuration of a laser processing system according to a comparative example.

FIG. 3 is a diagram schematically illustrating a configuration of a laser apparatus.

FIG. 4 is a flowchart schematically illustrating a flow of an operation of the laser processing system according to the comparative example.

FIG. 5 is a flowchart illustrating a flow of an operation at the time of laser hole processing.

FIG. 6 is a sectional SEM image after irradiation with 1 pulse.

FIG. 7 is a sectional SEM image after irradiation with 5 pulses.

FIG. 8 is a sectional SEM image after irradiation with 10 pulses.

FIG. 9 is a diagram describing how laser hole processing proceeds while maintaining a high aspect ratio.

FIG. 10 is a sectional SEM image after irradiation with 500 or more pulses.

FIG. 11 is a diagram schematically illustrating a first phase to a fourth phase of laser hole processing.

FIG. 12 is a microscopic image obtained by photographing a plurality of holes formed by a laser processing method according to the comparative example from a side face of a workpiece.

FIG. 13 is a SEM image illustrating a surface of a workpiece after irradiation with 3 pulses.

FIG. 14 is a SEM image illustrating that a product deposited on a surface of glass absorbs a laser beam.

FIG. 15 is a diagram illustrating a first step of depositing a product by laser ablation on a processing region.

FIG. 16 is a diagram illustrating a second step of performing laser hole processing to a processing region where a product is deposited.

FIG. 17 is a diagram illustrating an irradiation condition for laser ablation and an irradiation condition for laser hole processing.

FIG. 18 is a diagram schematically illustrating a configuration of a laser processing system according to a second embodiment.

FIG. 19 is a flowchart schematically illustrating a flow of an operation of the laser processing system according to the second embodiment.

FIG. 20 is a flowchart illustrating a flow of an operation at the time of laser ablation.

FIG. 21 is a diagram schematically illustrating a configuration of a laser processing system according to a third embodiment.

FIG. 22 is a diagram illustrating an example of a laser ablation region set on a surface of a workpiece.

FIG. 23 is a diagram illustrating how a product generated from a laser ablation region is deposited on a processing region.

FIG. 24 is a flowchart schematically illustrating a flow of an operation of the laser processing system according to the third embodiment.

FIG. 25 is a flowchart illustrating a flow of an operation at the time of laser ablation.

FIG. 26 is a diagram illustrating a modification of a laser ablation region.

FIG. 27 is a diagram schematically illustrating a configuration of a laser processing system according to a fourth embodiment.

FIG. 28 is a diagram describing a flow of an operation at the time of laser hole processing.

FIG. 29 is a diagram describing a flow of an operation at the time of laser hole processing according to a modification of the fourth embodiment.

FIG. 30 is a diagram schematically illustrating a configuration of a laser processing system according to a fifth embodiment.

FIG. 31 is a diagram illustrating a relationship between fluence of a pulse for laser ablation and fluence of a pulse for laser hole processing.

FIG. 32 is a flowchart schematically illustrating a flow of an operation of the laser processing system according to the fifth embodiment.

FIG. 33 is a flowchart illustrating a flow of an operation related to setting of an irradiation condition.

FIG. 34 is a flowchart illustrating a flow of an operation at the time of ablation and laser hole processing.

FIG. 35 is a diagram schematically illustrating a configuration of an electronic device.

FIG. 36 is a flowchart illustrating an electronic device manufacturing method.

### DESCRIPTION OF EMBODIMENTS

### Contents

1. Terms
   1.1 Deposition of Product by Laser Ablation
   1.2 Alkali-free Glass Substrate
   1.3 Fluence
2. Comparative Example
   2.1 Configuration
   2.2 Operation
   2.3 Problem
3. First Embodiment
   3.1 Laser Processing Method
   3.2 Effect
4. Second Embodiment
   4.1 Configuration
   4.2 Operation
   4.3 Effect
5. Third Embodiment
   5.1 Configuration
   5.2 Operation
   5.3 Effect
6. Fourth Embodiment
   6.1 Configuration
   6.2 Operation
   6.3 Effect
7. Fifth Embodiment
7.1 Configuration
7.2 Operation
8. Electronic Device Manufacturing Method

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference signs, and any redundant description thereof is omitted.

### 1. Terms

### 1.1 Deposition of Product by Laser Ablation

In the present disclosure, a phenomenon in which an irradiated portion is instantaneously sublimated by irradiating a glass substrate such as an alkali-free glass substrate with an ultraviolet pulse laser beam having high energy such as an excimer laser is called laser ablation.

Substances such as molecules, atoms, ions, clusters, electrons, and photons sublimated by irradiation with an ultraviolet pulse laser beam are directed to a substrate such as a workpiece while colliding with the atmosphere in a plasma state called a plume. Of the plume, the substance that has reached the substrate is deposited on the substrate in a porous state. In the present disclosure, a substance generated by the laser ablation is referred to as a product by the laser ablation.

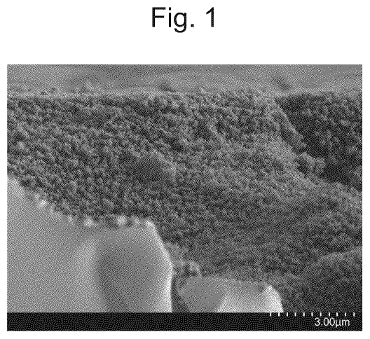

FIG. 1 illustrates a porous product deposited by irradiating an alkali-free glass substrate with an ultraviolet pulse laser beam.

### 1.2 Alkali-Free Glass Substrate

An alkali-free glass substrate is a substrate formed of glass containing no alkali components such as sodium and potassium. In general, alkali-free glass mainly includes silicon dioxide, aluminum oxide, or boron oxide, or an alkaline earth metal oxide such as calcium oxide or barium oxide. The alkali-free glass substrate is used, for example, as an insulating glass substrate for an interposer that relays an electrical connection between an integrated circuit chip and a circuit board.

### 1.3 Fluence

In the present disclosure, fluence represents an energy density of one pulse of an ultraviolet pulse laser beam. A unit of the fluence is J/cm².

### 2. Comparative Example

### 2.1 Configuration

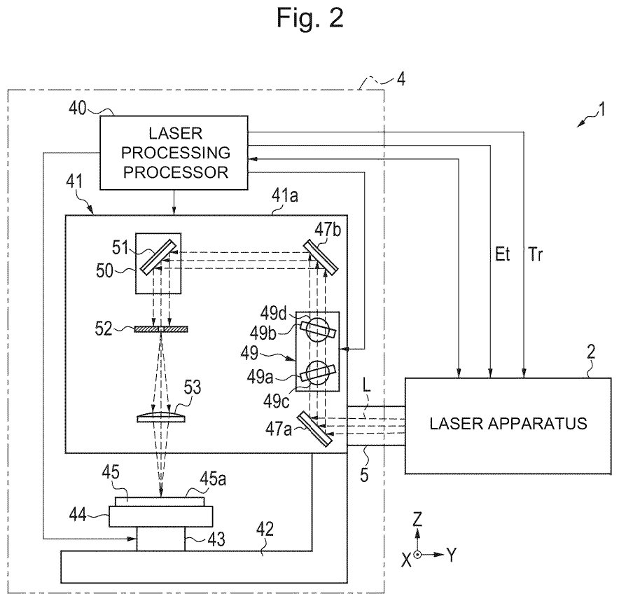

FIG. 2 schematically illustrates a configuration of a laser processing system 1 according to a comparative example. The comparative example of the present disclosure is an example recognized by the applicant as known only by the applicant, and is not a publicly known example admitted by the applicant.

The laser processing system 1 mainly includes a laser apparatus 2 and a laser processing apparatus 4. The laser processing system 1 is used for laser hole processing of forming a hole such as a via hole in a glass substrate for an interposer.

The laser apparatus 2 outputs an ultraviolet pulse laser beam. For example, the laser apparatus 2 is a discharge excitation type laser apparatus that outputs an ultraviolet pulse laser beam using a F₂, ArF, KrF, XeCl, XeF or the like as a laser medium. In the present disclosure, the laser apparatus 2 is a KrF excimer laser apparatus that outputs an ultraviolet pulse laser beam having a center wavelength of 248.4 nm. Hereinafter, the ultraviolet pulse laser beam output from the laser apparatus 2 is simply referred to as a laser beam L.

The laser apparatus 2 and the laser processing apparatus 4 are connected by an optical path pipe 5. The optical path pipe 5 is disposed on an optical path of the laser beam L between an exit port of the laser apparatus 2 and an entrance port of the laser processing apparatus 4.

The laser processing apparatus 4 includes a laser processing processor 40, an optical device 41, a frame 42, a moving stage 43, and a table 44. The optical device 41 and the moving stage 43 are fixed to the frame 42.

The table 44 supports a workpiece 45. The workpiece 45 is a processing target to be irradiated with the laser beam L and to be subjected to the laser hole processing. The workpiece 45 is a glass substrate for an interposer, and is, for example, an alkali-free glass substrate transparent to the laser beam L.

The moving stage 43 supports the table 44. The workpiece 45 is fixed on the table 44. The moving stage 43 is movable in an X direction, a Y direction, and a Z direction, and a position of the workpiece 45 can be adjusted by adjusting a position of the table 44. The X direction, the Y direction, and the Z direction are orthogonal to each other. The X direction and the Y direction are parallel to a surface 45a of the workpiece 45 on which the laser beam L is incident. The Z direction is orthogonal to the surface 45a.

Under control of the laser processing processor 40, the moving stage 43 adjusts the position of the workpiece 45 so that a desired processing position in a processing region is irradiated with the laser beam L output from the optical device 41. In the present disclosure, the processing region refers to a region including one or more processing positions.

The optical device 41 includes a housing 41a, high reflective mirrors 47a and 47b, an attenuator 49, an introduction optical system 50, a mask 52, and a projection optical system 53, and transfers an image having a shape of a hole to be processed to the surface 45a of the workpiece 45.

The high reflective mirror 47a is disposed so as to reflect the laser beam L that has passed through the optical path pipe 5, and to allow the reflected laser beam L to pass through the attenuator 49 so that the reflected laser beam L is incident on the high reflective mirror 47b. The optical path pipe 5 and the housing 41a are purged with nitrogen gas, for example.

The attenuator 49 is disposed in the housing 41a on an optical path between the high reflective mirror 47a and the high reflective mirror 47b. The attenuator 49 includes, for example, two partial reflective mirrors 49a and 49b and rotating stages 49c and 49d of the partial reflective mirrors. The partial reflective mirrors 49a and 49b are optical elements transmittances of which change depending on an incident angle of the laser beam L. In the partial reflective mirrors 49a and 49b, the incident angle of the laser beam L is adjusted by the rotating stages 49c and 49d so that the fluence of the laser beam L with which the surface 45a of the workpiece 45 is irradiated becomes a target value.

The high reflective mirror 47b is disposed so as to reflect the laser beam L that has passed through the attenuator 49 and to allow the reflected laser beam L to enter the introduction optical system 50.

The introduction optical system 50 includes a high reflective mirror 51, and is disposed such that, for example, the mask 52 is Kohler-illuminated with a rectangular beam and light intensity of the laser beam L on the mask 52 is uniform. Note that the light intensity on the mask 52 may be made uniform via an unillustrated illumination system including a fly-eye lens and a condenser lens.

The mask 52 is provided with, for example, a pattern of a metal or dielectric multilayer film on a synthetic quartz substrate through which ultraviolet light is transmitted. For example, on the mask 52, a pattern for processing a hole having a diameter of 5 μm to 30 μm in the workpiece 45 is formed. When projection magnification of the projection optical system 53 is M, a pattern having a size that is 1/M of a processing size is formed on the mask 52.

The projection optical system 53 is a reduction projection optical system that reduces and projects an image of the mask 52, and is disposed such that the image of the mask 52 is formed on the surface 45a of the workpiece 45. The projection optical system 53 may be a single lens or an aberration corrected lens unit.

The laser processing processor 40 transmits target pulse energy Et and a light emission trigger Tr to the laser apparatus 2. The target pulse energy Et has a target value of pulse energy of the laser beam L. The light emission trigger Tr is a trigger signal for causing the laser apparatus 2 to output the laser beam L for one pulse.

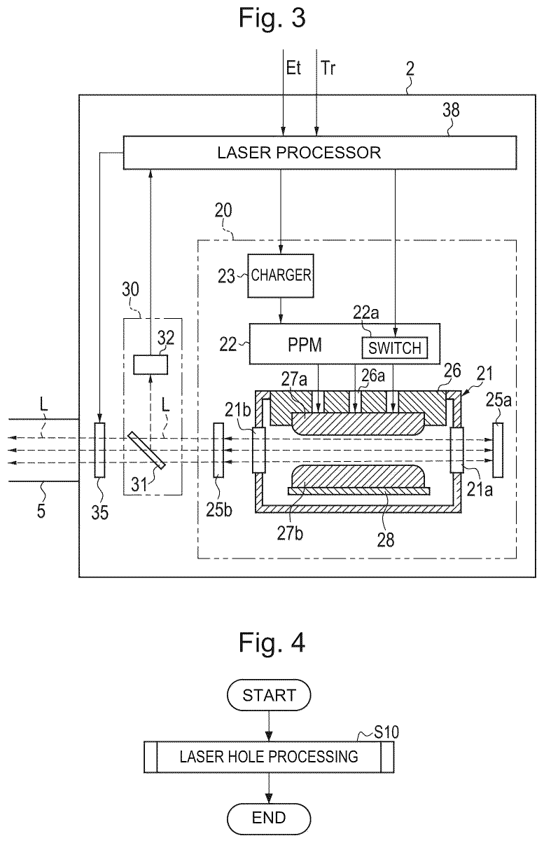

FIG. 3 schematically illustrates a configuration of the laser apparatus 2. The laser apparatus 2 includes an oscillator 20, a monitor module 30, a shutter 35, and a laser processor 38. The oscillator 20 includes a chamber 21, an optical resonator formed of a rear mirror 25a and an output coupling mirror (OC: Output Coupler) 25b, a charger 23, and a power supply unit (PPM: Pulsed Power Module) 22.

The chamber 21 is provided with windows 21a and 21b. A laser gas as a laser medium is enclosed in the chamber 21.

In addition, an opening is formed in the chamber 21, and an electrically insulating plate 26 in which a plurality of feedthroughs 26a are embedded is provided so as to close the opening. The PPM 22 is disposed on the electrically insulating plate 26. In the chamber 21, a pair of discharge electrodes 27a and 27b as main electrodes and a ground plate 28 are disposed. Discharge surfaces of the discharge electrodes 27a and 27b each have a rectangular shape.

The discharge electrodes 27a and 27b are disposed such that their discharge surfaces face each other in order to excite the laser medium by discharge. The discharge electrode 27a is supported by the electrically insulating plate 26 on a surface opposite to the discharge surface. The discharge electrode 27a is connected to the feedthroughs 26a. The discharge electrode 27b is supported by the ground plate 28 on a surface opposite to the discharge surface.

The PPM 22 includes a switch 22a, an unillustrated charging capacitor, an unillustrated pulse transformer, an unillustrated magnetic compression circuit, and an unillustrated peaking capacitor. The peaking capacitor is connected to the feedthroughs 26a via an unillustrated connecting portion. The charger 23 charges the charging capacitor based on control from the laser processor 38.

The switch 22a is on/off-controlled by the laser processor 38. The laser processor 38 turns on the switch 22a in response to the light emission trigger Tr transmitted from the laser processing processor 40.

When the switch 22a is turned on, a current flows from the charging capacitor to a primary side of the pulse transformer, and a current in an opposite direction flows to a secondary side of the pulse transformer by electromagnetic induction. The magnetic compression circuit is connected to the secondary side of the pulse transformer and compresses a pulse width of a current pulse. The peaking capacitor is charged with this current pulse. When a voltage of the peaking capacitor reaches a breakdown voltage of the laser gas, dielectric breakdown occurs in the laser gas between the discharge electrodes 27a and 27b to cause discharge. By this discharge, the laser beam L for one pulse is generated.

The rear mirror 25a has a high reflective film coated on a planar substrate. The output coupling mirror 25b has a partial reflective film coated on a planar substrate. The chamber 21 is disposed between the rear mirror 25a and the output coupling mirror 25b. The laser beam generated in the chamber 21 is amplified by the optical resonator and is output from the output coupling mirror 25b.

The monitor module 30 includes a beam splitter 31 and a photosensor 32. The beam splitter 31 is disposed on an optical path of the laser beam L output from the output coupling mirror 25b, and reflects a part of the laser beam L. The photosensor 32 is disposed at a position on which the laser beam L reflected by the beam splitter 31 is incident. The photosensor 32 measures the pulse energy of the laser beam L and transmits a measured value to the laser processor 38.

The laser processor 38 changes a charging voltage of the charger 23 based on the measured value of the pulse energy by the photosensor 32 to control the pulse energy of the laser beam L output from the laser apparatus 2 to be the target pulse energy Et.

The shutter 35 is disposed on an optical path of the laser beam L transmitted through the beam splitter 31. The shutter 35 is opened and closed in response to a command from the laser processor 38. The laser processor 38 controls the shutter 35 to control output of the laser beam L from the laser apparatus 2.

### 2.2 Operation

Next, an operation of the laser processing system 1 according to the comparative example will be described. FIG. 4 schematically illustrates a flow of the operation of the laser processing system 1 according to the comparative example. When performing the laser hole processing, the workpiece 45 is set on the table 44 of the moving stage 43. The laser processing processor 40 controls each part of the laser processing system 1 so as to perform the laser hole processing on the workpiece 45 with the laser beam L (step S10).

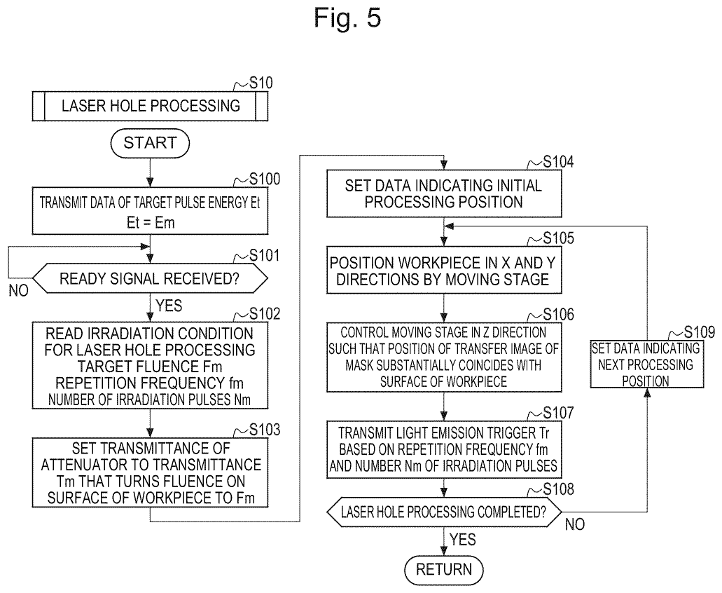

FIG. 5 illustrates a flow of an operation at the time of the laser hole processing. First, the laser processing processor 40 transmits data of the target pulse energy Et required for the laser hole processing to the laser apparatus 2 (step S100). Here, the laser processing processor 40 defines that Et is Em. After receiving the data, the laser apparatus 2 controls the chamber 21, and transmits a ready signal to the laser processing processor 40 when the laser beam L having the target pulse energy Et can be output.

The laser processing processor 40 determines whether or not the ready signal has been received from the laser apparatus 2 (step S101). When it is determined that the ready signal has been received (step S101: YES), the laser processing processor 40 reads an irradiation condition for the laser hole processing (step S102). The irradiation condition includes target fluence Fm, a repetition frequency fm of the pulse of the laser beam L, and the number Nm of irradiation pulses. The irradiation condition may be read from an unillustrated external device, via a network, or from an input device operated by an operator.

The laser processing processor 40 sets a transmittance of the attenuator 49 to a transmittance Tm that turns the fluence of the laser beam L on the surface 45a of the workpiece 45 to the target fluence Fm (step S103). Here, the laser processing processor 40 uses, for example, the transmittance Tm calculated using Equation (1) below.

Tm=(1/T′)×Sm×(Fm/Em) (1)

A transmittance of the optical device 41 when the transmittance of the attenuator 49 is 100% is denoted by T′. Area of a transfer image of the mask 52 on the surface 45a of the workpiece 45 is denoted by Sm. In step S103, the laser processing processor 40 controls incident angles on the partial reflective mirrors 49a and 49b by the rotating stages 49c and 49d so that the transmittance of the attenuator 49 is Tm.

The laser processing processor 40 sets data indicating an initial processing position in the processing region of the workpiece 45 (step S104). The laser processing processor 40 controls the moving stage 43 based on the set data to position the workpiece 45 in the X and Y directions (step S105). Further, the laser processing processor 40 controls the moving stage 43 in the Z direction such that a position of the transfer image of the mask 52 substantially coincides with the surface 45a of the workpiece 45 (step S106).

The laser processing processor 40 transmits the light emission trigger Tr to the laser apparatus 2 based on the repetition frequency fm and the number Nm of irradiation pulses (step S107). Consequently, the laser beam L is output from the laser apparatus 2 in synchronization with the light emission trigger Tr, and enters the laser processing apparatus 4 through the optical path pipe 5. The laser beam L is reflected by the high reflective mirror 47a, is attenuated by the attenuator 49, and is then reflected by the high reflective mirror 47b. The laser beam L reflected by the high reflective mirror 47b is reflected by the high reflective mirror 51 of the introduction optical system 50 and incident on the mask 52. The laser beam L transmitted through the mask 52 enters the projection optical system 53. The laser beam L output from the projection optical system 53 forms an image of the mask 52 on the surface 45a of the workpiece 45. Then, a hole is formed by the laser ablation.

The laser processing processor 40 determines whether or not the laser hole processing to the processing region has been completed (step S108). Completion of the laser hole processing refers to the completion of the laser hole processing at all the processing positions in the processing region. When it is determined that the laser hole processing has not been completed (step S108: NO), the laser processing processor 40 sets data indicating a next processing position (step S109), and returns the process to step S105.

The laser processing processor 40 repeatedly executes step S105 to step S107 until the laser hole processing is completed. When it is determined that the laser hole processing has been completed (step S108: YES), the laser processing processor 40 ends the processing.

### 2.3 Problem

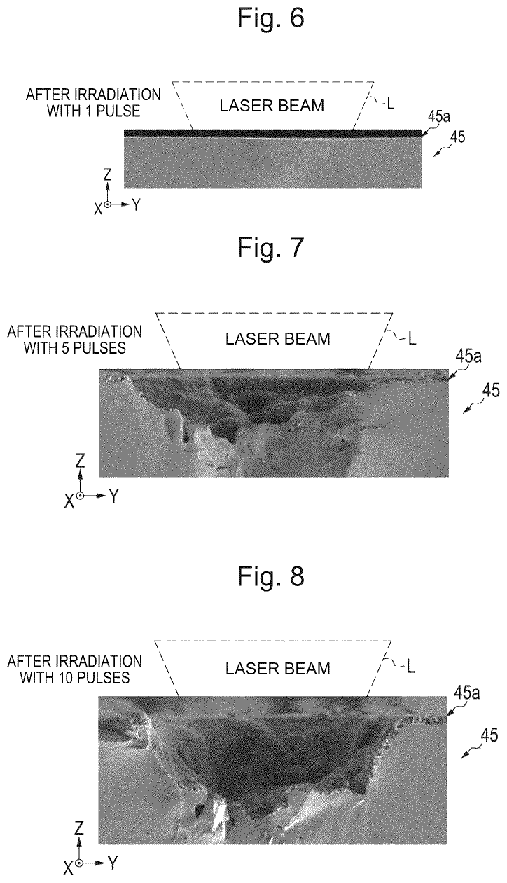

Next, a problem of the laser processing method according to the comparative example will be described. FIG. 6 to FIG. 8 are sectional SEM (Scanning Electron Microscope) images of the workpiece 45 after irradiation with one or more pulses of the laser beam L by the laser processing method according to the comparative example. FIG. 6 is a sectional SEM image after the irradiation with 1 pulse. FIG. 7 is a sectional SEM image after the irradiation with 5 pulses. FIG. 8 is a sectional SEM image after the irradiation with 10 pulses.

As illustrated in FIG. 6, no change occurs on the surface 45a of the workpiece 45 after the irradiation with 1 pulse. By the irradiation with 1 to 3 pulses, the surface 45a is altered, but the laser hole processing hardly proceeds. Hereinafter, a phase in which the laser hole processing hardly proceeds even when the irradiation with the laser beam L is performed is referred to as a first phase.

As illustrated in FIG. 7, after the irradiation with 5 pulses, a porous product by the laser ablation is ejected and deposited on the surface 45a and near the processed hole. This porous product has a high absorptance of the laser beam L, and thus has a function of advancing the laser hole processing. Since an amount of the product increases as the number of irradiation pulses increases, an absorption amount of the laser beam L further increases, and as illustrated in FIG. 8, the laser hole processing proceeds in a depth direction. In this way, by the irradiation with 4 to 10 pulses, the laser hole processing is made to proceed by the product by the laser ablation. Hereinafter, a phase in which the laser hole processing is made to proceed by the product by the laser ablation is referred to as a second phase.

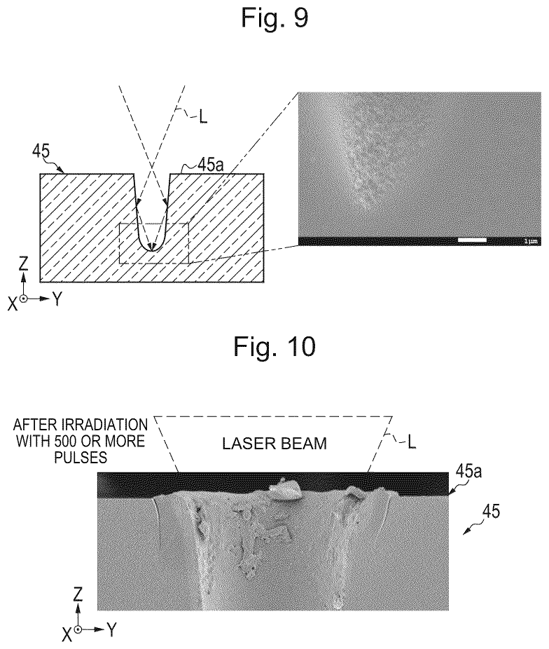

FIG. 9 illustrates how the laser hole processing proceeds while maintaining a high aspect ratio. By the irradiation with 10 to 499 pulses, the laser beam L not absorbed by the product self-converges inside the hole as the laser hole processing proceeds. It is presumed that the self-convergence is due to a waveguide effect caused by an inner wall of the hole being melted by the laser hole processing and thus the inner wall reflecting the laser beam L. The tapered inner wall makes the laser beam L self-converge at a terminus of the hole by the waveguide effect so that the laser hole processing proceeds while maintaining a high aspect ratio.

Further, according to the sectional SEM image illustrated in FIG. 9, it is recognized that the porous product is also generated at the terminus of the hole. Therefore, since the inner wall of the hole reflects the laser beam L and a high absorption state of the laser beam L is maintained at the tip, the laser hole processing proceeds while maintaining a high aspect ratio. Note that the product by the laser ablation is also discharged from an entrance of the hole. Hereinafter, a phase in which the laser hole processing proceeds while maintaining a high aspect ratio is referred to as a third phase.

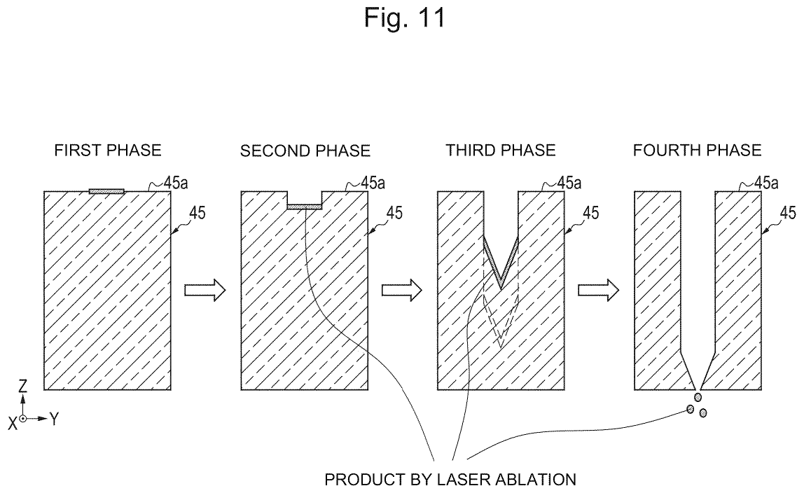

FIG. 10 is a sectional SEM image after the irradiation with 500 or more pulses. In FIG. 10, a hole penetrates the workpiece 45. After the hole penetrates the workpiece 45, an inner diameter of the hole is maintained small regardless of the number of irradiation pulses of the laser beam L with which the hole is irradiated. This is because most of the product by the laser ablation is discharged to the outside from the terminus of the hole since the hole penetrates the workpiece 45. Thus, since absorption of the laser beam L is suppressed inside the hole, the inner diameter of the hole is maintained small regardless of the number of irradiation pulses. Hereinafter, a phase after the hole penetrates the workpiece 45 is referred to as a fourth phase.

FIG. 11 schematically illustrates the first phase to the fourth phase of the laser hole processing. In the first phase, the surface 45a of the workpiece 45 hardly changes, and the laser hole processing hardly proceeds. In the second phase, the laser hole processing is made to proceed by the product of laser ablation. In the third phase, the laser hole processing is made to proceed while maintaining a high aspect ratio by the self-convergence of the laser beam L. In the fourth phase, after penetrating the workpiece 45, the inner diameter of the hole is maintained small.

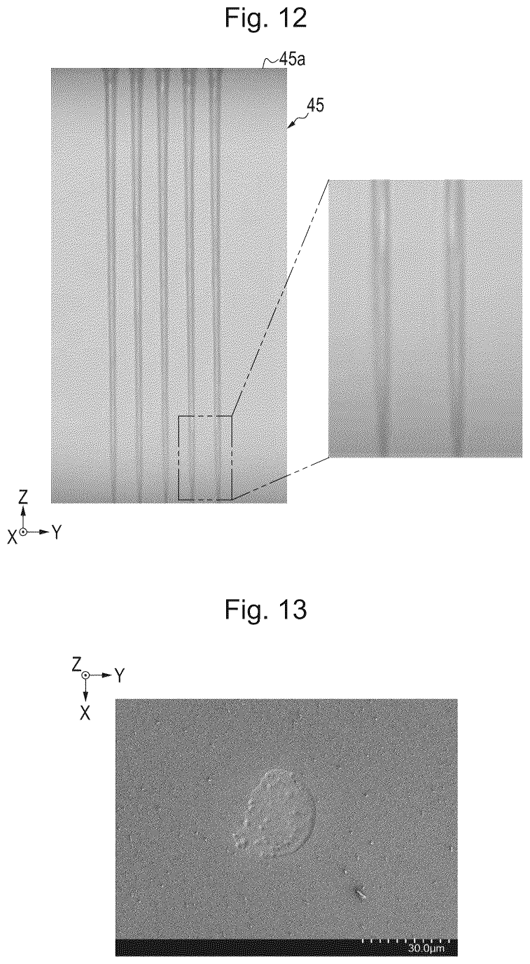

FIG. 12 is an optical microscopic image obtained by photographing a plurality of holes formed by the laser processing method according to the comparative example from a side face of the workpiece 45. As illustrated in FIG. 12, according to the laser processing method of the comparative example, a hole that penetrates the workpiece 45 and has a high aspect ratio can be formed.

According to the laser processing method of the comparative example, a hole having a high aspect ratio is formed by continuous pulse irradiation of the workpiece 45 with the laser beam L. However, since the pulses emitted in the first phase alter the surface 45a of the workpiece 45 but hardly contribute to the laser hole processing, the cumulative number of irradiation pulses increases.

FIG. 13 is a SEM image illustrating the surface 45a of the workpiece 45 after the irradiation with 3 pulses. As illustrated in FIG. 13, it is recognized that the pulses emitted in the first phase alter the surface 45a of the workpiece 45, but hardly contribute to the laser hole processing.

Therefore, the present disclosure provides a laser processing method, a laser processing apparatus, and an electronic device manufacturing method that can reduce the cumulative number of irradiation pulses by making contribution to the laser hole processing from the first pulse of the laser beam L.

### 3. First Embodiment

A laser processing method according to a first embodiment of the present disclosure will be described. Any component same as that described above is denoted by an identical sign, and redundant description thereof is omitted unless specific description is needed.

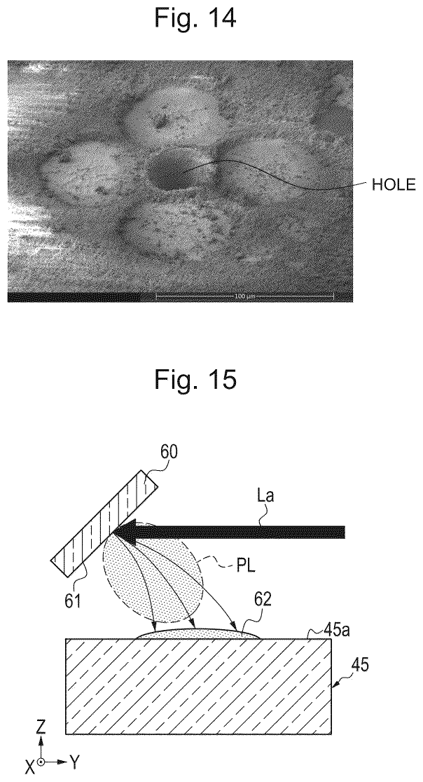

The applicant has found that, by performing the laser hole processing after depositing the product by the laser ablation on the processing region, contribution to the laser hole processing is made from the first pulse of the laser beam L. In order to verify this effect, as illustrated in FIG. 14, by forming a hole in a glass substrate by the laser hole processing, the product by the laser ablation was deposited on a surface of the glass substrate. Then, four parts around the hole where the product was deposited were irradiated with one pulse of the laser beam L. It was confirmed that the product deposited on the surface of the glass substrate absorbed the laser beam L to contribute to the laser hole processing from the first pulse.

### 3.1 Laser Processing Method

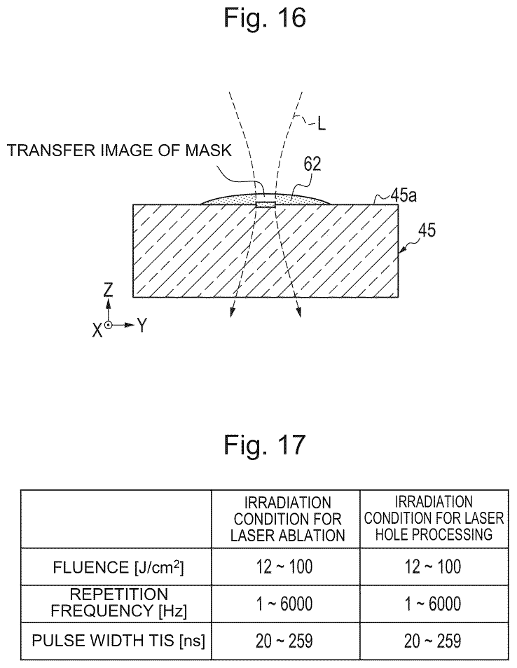

FIG. 15 and FIG. 16 conceptually illustrate the laser processing method according to the first embodiment. FIG. 15 illustrates a first step of depositing the product by the laser ablation on the processing region. FIG. 16 illustrates a second step of performing the laser hole processing to the processing region where the product is deposited.

In the first step, a target substrate 60 made of the same material as the workpiece 45 is disposed such that its surface 61 faces the surface 45a of the workpiece 45 at a fixed angle. For example, the target substrate 60 is an alkali-free glass substrate. Then, in the atmosphere, the surface 61 of the target substrate 60 is irradiated with a laser beam La capable of the laser ablation. Consequently, a plume PL is generated from the surface 61 of the target substrate 60, and a product 62 by the laser ablation is deposited on the surface 45a of the workpiece 45.

In the second step, the surface 45a of the workpiece 45 where the product 62 is deposited is irradiated with the laser beam L capable of the laser hole processing. Since the product 62 is porous and has a high absorptance of the laser beam L, it contributes to the laser hole processing from the first pulse, and the laser hole processing proceeds.

The laser beam La used for the laser ablation and the laser beam L used for the laser hole processing may be the same laser beam. The laser beam La and the laser beam L are, for example, ultraviolet pulse laser beams having the same center wavelength. For example, the center wavelength is 248.4 nm.

Note that the laser beam La is an example of a “first ultraviolet pulse laser beam” according to technology of the present disclosure. The laser beam L is an example of a “second ultraviolet pulse laser beam” according to the technology of the present disclosure. Further, the target substrate 60 is an example of a “first glass substrate” according to the technology of the present disclosure. The workpiece 45 is an example of a “second glass substrate” according to the technology of the present disclosure. In the present embodiment, the first glass substrate and the second glass substrate are different substrates.

FIG. 17 illustrates an irradiation condition for the laser ablation and an irradiation condition for the laser hole processing. Hereinafter, the irradiation condition for the laser ablation is referred to as a “first irradiation condition”, and the irradiation condition for the laser hole processing is referred to as a “second irradiation condition”. The first irradiation condition and the second irradiation condition include at least one of fluence, a repetition frequency, the number of irradiation pulses, and a pulse width.

As illustrated in FIG. 17, the fluence, the repetition frequency, and the pulse width may be same values in the first irradiation condition and the second irradiation condition. The number of irradiation pulses is different between the first irradiation condition and the second irradiation condition. The number of irradiation pulses in the second irradiation condition has a value that depends on a thickness of the workpiece 45.

The first irradiation condition and the second irradiation condition include irradiation positions of the first ultraviolet pulse laser beam and the second ultraviolet pulse laser beam. In the present embodiment, the target substrate 60 is irradiated with the laser beam La at the time of the laser ablation, and the workpiece 45 is irradiated with the laser beam L at the time of the laser hole processing. Therefore, in the present embodiment, the irradiation position is different between the first irradiation condition and the second irradiation condition.

Accordingly, the laser processing method according to the first embodiment includes depositing a product generated from the first glass substrate at a processing position of the second glass substrate by irradiating the first glass substrate with the first ultraviolet pulse laser beam under the first irradiation condition, and forming a hole by irradiating the processing position where the product is deposited with the second ultraviolet pulse laser beam under the second irradiation condition different from the first irradiation condition.

### 3.2 Effect

In the laser processing method according to the present embodiment, since the laser hole processing is performed by performing irradiation with the laser beam L after depositing the product 62 by the laser ablation on the surface 45a of the workpiece 45, the contribution to the laser hole processing is made from the first pulse of the laser beam L. Thus, the cumulative number of irradiation pulses can be reduced.

### 4. Second Embodiment

Next, as a second embodiment, a laser processing system 1a to which the laser processing method according to the first embodiment is applied will be described. Any component same as that described above is denoted by an identical sign, and redundant description thereof is omitted unless specific description is needed.

### 4.1 Configuration

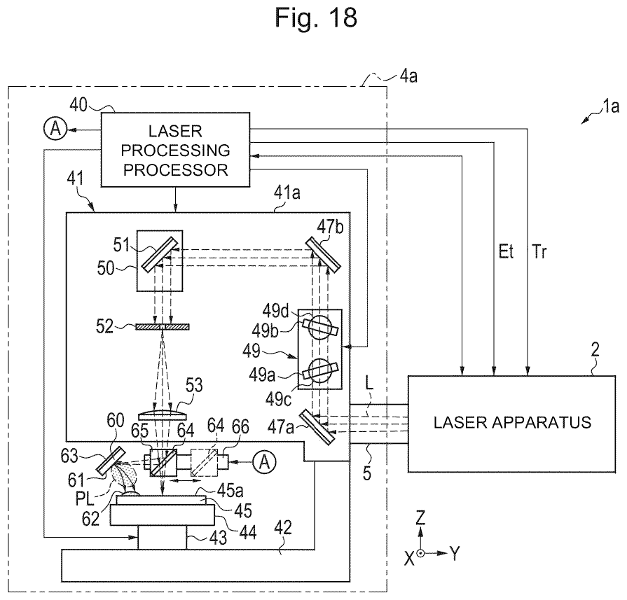

FIG. 18 schematically illustrates a configuration of the laser processing system 1a according to the second embodiment. The laser processing system 1a differs from the laser processing system 1 according to the comparative example in a configuration of a laser processing apparatus 4a. The laser processing apparatus 4a includes the target substrate 60, a high reflective mirror 64, and a linear stage 66, in addition to the configuration of the laser processing apparatus 4 according to the comparative example.

The target substrate 60 is made of the same material as the workpiece 45 in the same manner as in the first embodiment, and is, for example, an alkali-free glass substrate. The target substrate 60 is fixed by the holder 63 such that the surface 61 faces the surface 45a of the workpiece 45 at a fixed angle.

The high reflective mirror 64 is connected to the linear stage 66 via a holder 65. The linear stage 66 moves the high reflective mirror 64 under the control from the laser processing processor 40. The linear stage 66 is a moving mechanism that moves the high reflective mirror 64 between a position where the high reflective mirror 64 is inserted into an optical path of the laser beam L between the projection optical system 53 and the workpiece 45 and a position where the high reflective mirror 64 is withdrawn from the optical path.

The high reflective mirror 64 reflects the laser beam L and makes it incident on the surface 61 of the target substrate 60 when inserted into the optical path of the laser beam L, and the laser beam L is incident on the surface 45a of the workpiece 45 when the high reflective mirror 64 is withdrawn from the optical path of the laser beam L. In this way, in the present embodiment, the laser beam L is used for the laser ablation and the laser hole processing. Therefore, in the present embodiment, the first ultraviolet pulse laser beam and the second ultraviolet pulse laser beam are ultraviolet pulse laser beams output from the same laser apparatus 2. Further, in the present embodiment, the first glass substrate and the second glass substrate are irradiated selectively with the first ultraviolet pulse laser beam and the second ultraviolet pulse laser beam.

### 4.2 Operation

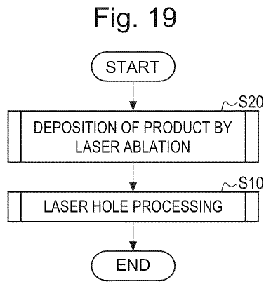

Next, an operation of the laser processing system 1a according to the second embodiment will be described. FIG. 19 schematically illustrates a flow of the operation of the laser processing system 1a according to the second embodiment. The operation of the laser processing system 1a according to the present embodiment differs from the comparative example in that step S20 of depositing the product 62 on the surface 45a of the workpiece 45 by the laser ablation is performed prior to step S10 of performing the laser hole processing on the workpiece 45.

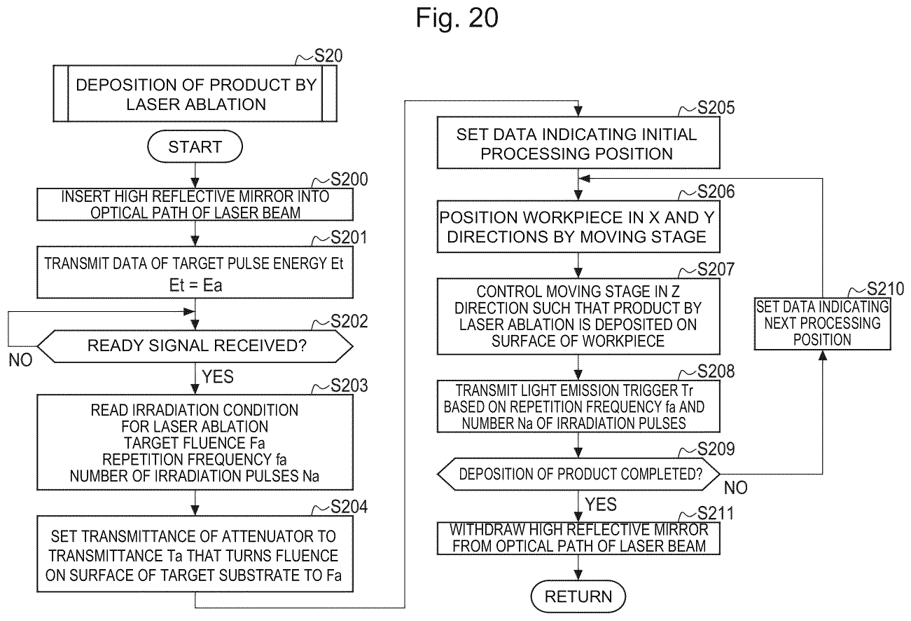

FIG. 20 illustrates a flow of the operation at the time of the laser ablation. First, the laser processing processor 40 inserts the high reflective mirror 64 into the optical path of the laser beam L by controlling the linear stage 66 (step S200).

The laser processing processor 40 transmits data of the target pulse energy Et required for the laser ablation to the laser apparatus 2 (step S201). Here, the laser processing processor 40 defines that Et is Ea. After receiving the data, the laser apparatus 2 controls the chamber 21, and transmits a ready signal to the laser processing processor 40 when the laser beam L having the target pulse energy Et can be output.

The laser processing processor 40 determines whether or not the ready signal has been received from the laser apparatus 2 (step S202). When it is determined that the ready signal has been received (step S202: YES), the laser processing processor 40 reads an irradiation condition for the laser ablation (step S203). The irradiation condition includes target fluence Fa, a repetition frequency fa of the pulse of the laser beam L, and the number Na of irradiation pulses. The irradiation condition may be read from an unillustrated external device, via a network, or from an input device operated by an operator.

The laser processing processor 40 sets the transmittance of the attenuator 49 to a transmittance Ta that turns the fluence of the laser beam L on the surface 61 of the target substrate 60 to the target fluence Fa (step S204). Here, the laser processing processor 40 uses, for example, the transmittance Ta calculated using Equation (2) below.

Ta=(1/T′)×Sa×(Fa/Ea) (2)

Irradiation area of the laser beam L on the surface 61 of the target substrate 60 is denoted by Sa. In step S204, the laser processing processor 40 controls incident angles on the partial reflective mirrors 49a and 49b by the rotating stages 49c and 49d so that the transmittance of the attenuator 49 is Ta.

The laser processing processor 40 sets data indicating an initial processing position in the processing region of the workpiece 45 (step S205). The laser processing processor 40 controls the moving stage 43 based on the set data to position the workpiece 45 in the X and Y directions (step S206). Further, the laser processing processor 40 controls the moving stage 43 in the Z direction such that the product 62 by the laser ablation is deposited on the surface 45a of the workpiece 45 (step S207).

The laser processing processor 40 transmits the light emission trigger Tr to the laser apparatus 2 based on the repetition frequency fa and the number Na of irradiation pulses (step S208). Consequently, the laser beam L is output from the laser apparatus 2 in synchronization with the light emission trigger Tr, and enters the laser processing apparatus 4 through the optical path pipe 5. The laser beam L is reflected by the high reflective mirror 47a, is attenuated by the attenuator 49, and is then reflected by the high reflective mirror 47b. The laser beam L reflected by the high reflective mirror 47b is reflected by the high reflective mirror 51 of the introduction optical system 50 and incident on the mask 52. The laser beam L transmitted through the mask 52 enters the projection optical system 53. The laser beam L output from the projection optical system 53 is incident on the surface 61 of the target substrate 60 by being reflected by the high reflective mirror 64. Thus, the product 62 by the ablation is deposited at the processing position on the surface 45a of the workpiece 45.

The laser processing processor 40 determines whether or not deposition of the product 62 has been completed (step S209). Completion of the deposition of the product 62 refers to the completion of the deposition of the product 62 at all the processing positions in the processing region. When it is determined that the deposition of the product 62 has not been completed (step S209: NO), the laser processing processor 40 sets data indicating the next processing position (step S201), and returns the process to step S206.

The laser processing processor 40 repeatedly executes step S206 to step S208 until the deposition of the product 62 is completed. Since high accuracy is not required for positioning of the workpiece 45 in the Z direction at the time of the laser ablation, it is not necessary to perform step S207 in second and subsequent repetition loops.

When it is determined that the laser hole processing has been completed (step S209: YES), the laser processing processor 40 controls the linear stage 66 to withdraw the high reflective mirror 64 from the optical path of the laser beam L (step S211), and ends the processing.

Thereafter, in step S10 illustrated in FIG. 19, the laser hole processing is performed to each processing position where the product 62 is deposited. The processing of the laser processing processor 40 in step S10 is the same as that of the comparative example.

### 4.3 Effect

The laser processing apparatus 4a according to the present embodiment can deposit the product 62 by the laser ablation and perform the laser hole processing at the processing position where the product 62 is deposited using the laser beam L output from the laser apparatus 2. In this way, according to the present embodiment, it is possible to efficiently deposit the product 62 and perform the laser hole processing by one laser processing system 1a. In the present embodiment, as in the first embodiment, since the contribution to the laser hole processing is made from the first pulse of the laser beam L, the cumulative number of irradiation pulses can be reduced.

While the target substrate 60 is irradiated with the laser beam L transmitted through the mask 52 at the time of the laser ablation in the present embodiment, the mask 52 may be withdrawn from the optical path of the laser beam L at the time of the laser ablation. In this case, the laser processing apparatus 4a is preferably configured such that the target substrate 60 can be disposed at a focal position of the projection optical system 53. Thus, even when the pulse energy of the laser beam L output from the laser apparatus 2 is the same, the fluence at the time of the laser ablation can be made higher than the fluence at the time of the laser hole processing, and a deposition amount of the product 62 can be increased.

While the laser apparatus 2 is an excimer laser apparatus in the present embodiment, the laser apparatus 2 is not limited to the excimer laser apparatus. For example, the laser apparatus 2 may be a YAG laser apparatus that outputs a laser beam having a wavelength of about 1.03 μm to 1.06 μm, or a solid-state laser apparatus that includes a nonlinear crystal and outputs fourth harmonic waves (having a wavelength of 257.5 nm to 266 nm) of a fiber laser.

### 5. Third Embodiment

Next, a laser processing system 1b according to a third embodiment will be described. Any component same as that described above is denoted by an identical sign, and redundant description thereof is omitted unless specific description is needed.

### 5.1 Configuration

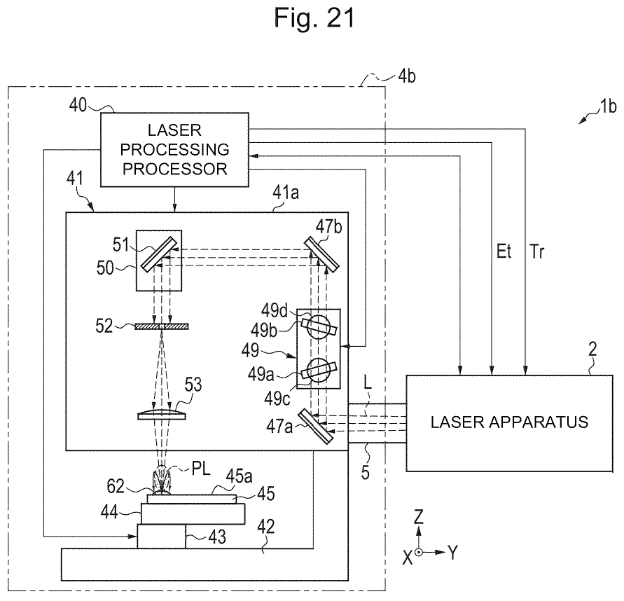

FIG. 21 schematically illustrates a configuration of the laser processing system 1b according to the third embodiment. The laser processing system 1b differs from the laser processing system 1a according to the second embodiment in a configuration of a laser processing apparatus 4b. The laser processing apparatus 4b is obtained by removing the target substrate 60, the high reflective mirror 64, and the linear stage 66 from the laser processing apparatus 4a according to the second embodiment. That is, the laser processing apparatus 4b has the same configuration as that of the laser processing apparatus 4 according to the comparative example.

### 5.2 Operation

In the present embodiment, the laser processing processor 40 defines a part of the surface 45a of the workpiece 45 as a laser ablation region, and causes the product 62 generated by irradiating the laser ablation region with the laser beam L to be deposited on the processing region. Therefore, in the present embodiment, the first glass substrate and the second glass substrate according to the technology of the present disclosure are both the workpiece 45, and are the same substrate.

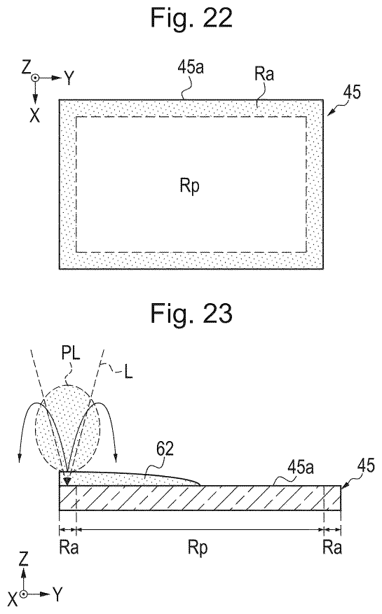

FIG. 22 illustrates an example of a laser ablation region Ra set on the surface 45a of the workpiece 45. As illustrated in FIG. 22, the laser processing processor 40 sets, for example, a peripheral part of a processing region Rp on the surface 45a of the workpiece 45 as the laser ablation region Ra.

As illustrated in FIG. 23, the laser processing processor 40 causes the product 62 generated by irradiating the laser ablation region Ra with the laser beam L to be deposited on the processing region Rp. Hereinafter, a position to be irradiated with the laser beam L to cause the ablation in the laser ablation area Ra is referred to as a laser ablation position. The laser processing processor 40 causes the product 62 to be deposited over the entire processing region Rp by sequentially changing the laser ablation position within the laser ablation region Ra.

In the present embodiment, since the irradiation position of the laser beam L is different between the time of the laser ablation and the time of the laser hole processing, the first irradiation condition and the second irradiation condition are different.

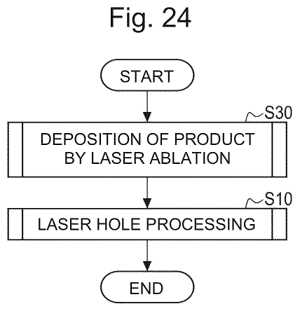

FIG. 24 schematically illustrates a flow of an operation of the laser processing system 1b according to the third embodiment. In the operation of the laser processing system 1b according to the present embodiment, step S30 of depositing the product 62 by the laser ablation is different from step S20 of the second embodiment. Hereinafter, descriptions that overlap with step S20 of the second embodiment will be appropriately omitted.

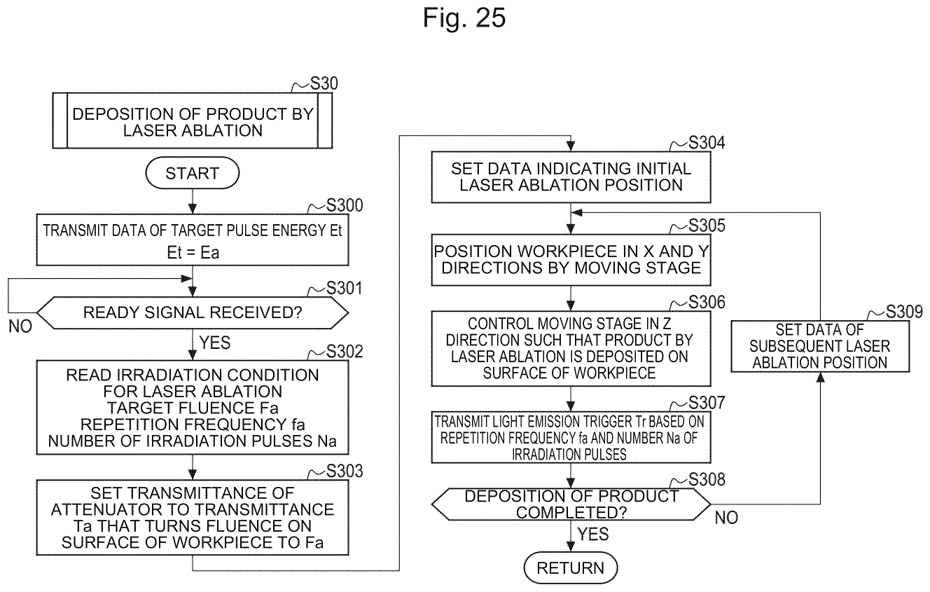

FIG. 25 illustrates a flow of the operation at the time of the laser ablation. First, the laser processing processor 40 transmits data of the target pulse energy Et required for the laser ablation to the laser apparatus 2 (step S300). Here, the laser processing processor 40 defines that Et is Ea.

The laser processing processor 40 determines whether or not a ready signal has been received from the laser apparatus 2 (step S301). When it is determined that the ready signal has been received (step S301: YES), the laser processing processor 40 reads an irradiation condition for the laser ablation (step S302).

The laser processing processor 40 sets the transmittance of the attenuator 49 to the transmittance Ta that turns the fluence of the laser beam L on the surface 45a of the workpiece 45 to the target fluence Fa (step S303).

The laser processing processor 40 sets data indicating an initial processing position in the laser ablation region Ra (step S304). The laser processing processor 40 controls the moving stage 43 based on the set data to position the workpiece 45 in the X and Y directions (step S305). Further, the laser processing processor 40 controls the moving stage 43 in the Z direction such that the product 62 by the laser ablation is deposited on the surface 45a of the workpiece 45 (step S306).

The laser processing processor 40 transmits the light emission trigger Tr to the laser apparatus 2 based on the repetition frequency fa and the number Na of irradiation pulses (step S307). Thus, the laser ablation position in the laser ablation area Ra is irradiated with the laser beam L output from the projection optical system 53. Consequently, the product 62 by the ablation is deposited on a part of the processing region Rp adjacent to the laser ablation position.

The laser processing processor 40 determines whether or not the deposition of the product 62 has been completed (step S308). The completion of the deposition of the product 62 refers to the completion of the deposition of the product 62 in the processing region Rp. When it is determined that the deposition of the product 62 has not been completed (step S308: NO), the laser processing processor 40 sets data indicating the next processing position (step S309), and returns the process to step S305.

The laser processing processor 40 repeatedly executes step S305 to step S307 until the deposition of the product 62 is completed. Since high accuracy is not required for positioning of the workpiece 45 in the Z direction at the time of the laser ablation, it is not necessary to perform step S306 in the second and subsequent repetition loops.

When it is determined that the deposition of the product 62 has been completed (step S308: YES), the laser processing processor 40 ends the processing.

Thereafter, in step S10 illustrated in FIG. 24, the laser hole processing is performed to the processing region Rp where the product 62 is deposited. The processing of the laser processing processor 40 in step S10 is the same as that of the comparative example.

### 5.3 Effect

According to the present embodiment, the same effects as those of the second embodiment can be obtained, and the product 62 by the ablation can be deposited on the processing region Rp without using the target substrate 60.

While the laser ablation region Ra is irradiated with the laser beam L transmitted through the mask 52 at the time of the laser ablation in the present embodiment, the mask 52 may be withdrawn from the optical path of the laser beam L at the time of the laser ablation. In this case, the laser processing apparatus 4a is preferably configured such that the laser ablation region Ra can be disposed at the focal position of the projection optical system 53. Thus, even when the pulse energy of the laser beam L output from the laser apparatus 2 is the same, the fluence at the time of the laser ablation can be made higher than the fluence at the time of the laser hole processing, and the deposition amount of the product 62 can be increased.

Further, while the peripheral part of one processing region Rp on the surface 45a of the workpiece 45 is set as the laser ablation region Ra in the present embodiment, the present invention is not limited thereto, and the laser ablation region Ra can be appropriately changed.

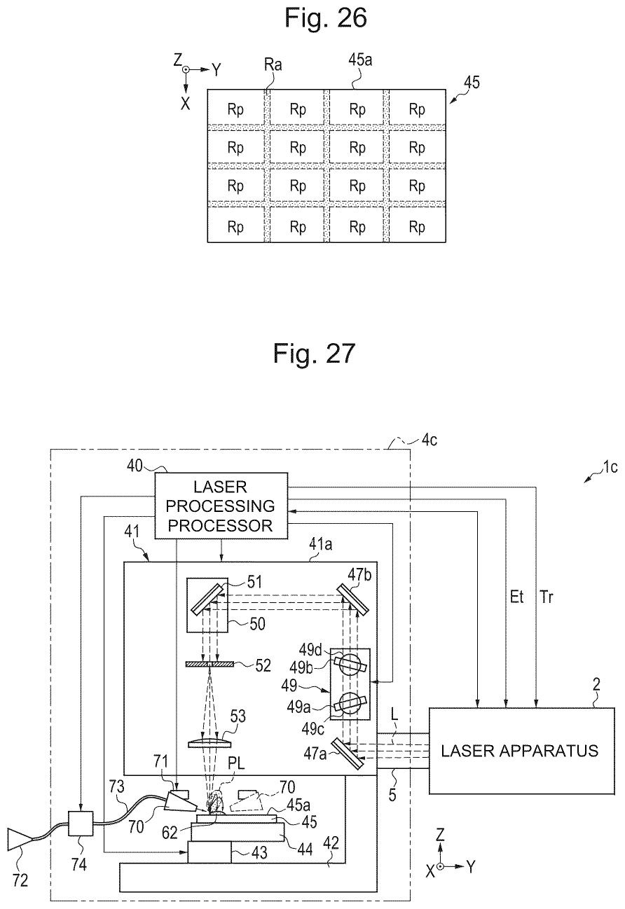

FIG. 26 illustrates a modification of the laser ablation area Ra. In FIG. 26, the laser ablation area Ra is set in a grid pattern on the surface 45a of the workpiece 45. In the present modification, the regions sectioned by the laser ablation region Ra in the grid pattern are the processing regions Rp. In such a manner, when the laser ablation region Ra is formed in the grid pattern, the product 62 can be uniformly deposited on the processing regions Rp.

Further, each processing region Rp is preferably set to be substantially the same size as a chip of an interposer. In this case, since the laser ablation region Ra is a region to be cut in order to separate the processing regions Rp, the entire workpiece 45 can be used to create the chips of the interposer without generating any waste.

### 6. Fourth Embodiment

Next, a laser processing system 1c according to a fourth embodiment will be described. Any component same as that described above is denoted by an identical sign, and redundant description thereof is omitted unless specific description is needed.

### 6.1 Configuration

FIG. 27 schematically illustrates a configuration of the laser processing system 1c according to the fourth embodiment. The laser processing system 1c differs from the laser processing system 1b according to the third embodiment in a configuration of a laser processing apparatus 4c. The laser processing apparatus 4c includes a nozzle 70 and a rotating stage 71 in addition to the configuration of the laser processing apparatus 4b according to the third embodiment.

A gas supply source 72 is connected to the nozzle 70 via a pipe 73. A gas flow rate control valve 74 is provided in the middle of the pipe 73. The nozzle 70 ejects a gas supplied from the gas supply source 72 toward a processing position to be irradiated with the laser beam L on the surface 45a of the workpiece 45. For example, the gas ejected by the nozzle 70 is a purge gas such as dry air.

Further, the nozzle 70 is held by the rotating stage 71. The rotating stage 71 rotates the nozzle 70 about a rotation axis parallel to the Z direction. The rotation of the nozzle 70 changes a direction in which the gas is ejected to the processing position. The rotating stage 71 and the gas flow rate control valve 74 are controlled by the laser processing processor 40.

### 6.2 Operation

Next, an operation of the laser processing system 1c according to the fourth embodiment will be described. In the present embodiment, setting of a laser ablation region as in the third embodiment is not performed. Further, in the present embodiment, the laser ablation as an operation different from the laser hole processing is not performed, and the product 62 is deposited on the processing region by utilizing the laser ablation caused at the time of the laser hole processing. Specifically, in the present embodiment, the product 62 by the laser ablation generated at the time of the laser hole processing is deposited at the next processing position by the gas ejected from the nozzle 70. At the next processing position, since the product 62 is deposited, the contribution to the laser hole processing is made from the first pulse of the laser beam L.

In the present embodiment, the first glass substrate and the second glass substrate according to the technology of the present disclosure are both the workpiece 45, and are the same substrate. Further, in the present embodiment, the product 62 deposited at the processing position of the laser hole processing is generated by the ablation at a different processing position. Therefore, in the present embodiment as well, the irradiation position of the laser beam L is different between the time of the laser ablation and the time of the laser hole processing, and the first irradiation condition and the second irradiation condition are different.

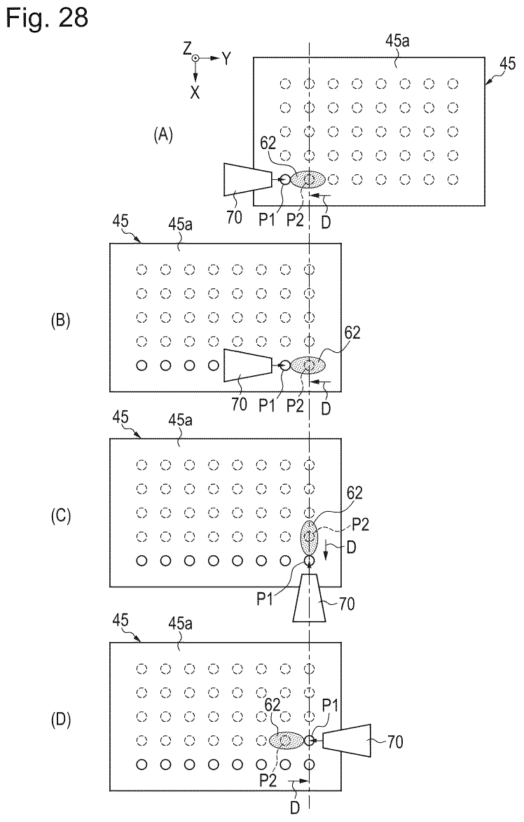

FIG. 28 illustrates a flow of an operation at the time of the laser hole processing. The laser processing processor 40 controls an ejecting direction of the gas from the nozzle 70 by controlling the rotating stage 71 in addition to the control of each component described in the comparative example.

In FIG. 28, a sign P1 indicates a processing position during the laser hole processing. A sign P2 indicates a next processing position. An arrow D indicates a moving direction of the workpiece 45 by the moving stage 43 for making a target position of the laser hole processing be the next processing position P2. The laser processing processor 40 sets the ejecting direction of the gas from the nozzle 70 to a direction opposite to the moving direction D of the workpiece 45. Thus, the product 62 by the laser ablation at the processing position P1 during the laser hole processing is deposited at the next processing position P2.

When the laser hole processing to the processing position P1 is completed, the laser processing processor 40 moves the workpiece 45, and then performs the laser hole processing to the processing position P2 where the product 62 is deposited. The product 62 generated by the laser hole processing is further deposited at the next processing position P2.

In FIGS. 28(A) and 28(B), since the moving direction D of the workpiece 45 is a −Y direction, the laser processing processor 40 sets the ejecting direction of the gas to a +Y direction. In FIG. 28(C), since the moving direction D of the workpiece 45 is a +X direction, the laser processing processor 40 sets the ejecting direction of the gas to a −X direction. In FIG. 28(D), since the moving direction D of the workpiece 45 is the +Y direction, the laser processing processor 40 sets the ejecting direction of the gas to the −Y direction.

### 6.3 Effect

In the present embodiment, since the product 62 by the laser ablation generated at the time of the laser hole processing is deposited at the next processing position by the gas, setting of a laser ablation region as in the third embodiment is not needed. Further, since it is not necessary to perform the laser ablation as an operation different from the laser hole processing, the cumulative number of irradiation pulses for which the laser ablation and the laser hole processing are combined can be reduced.

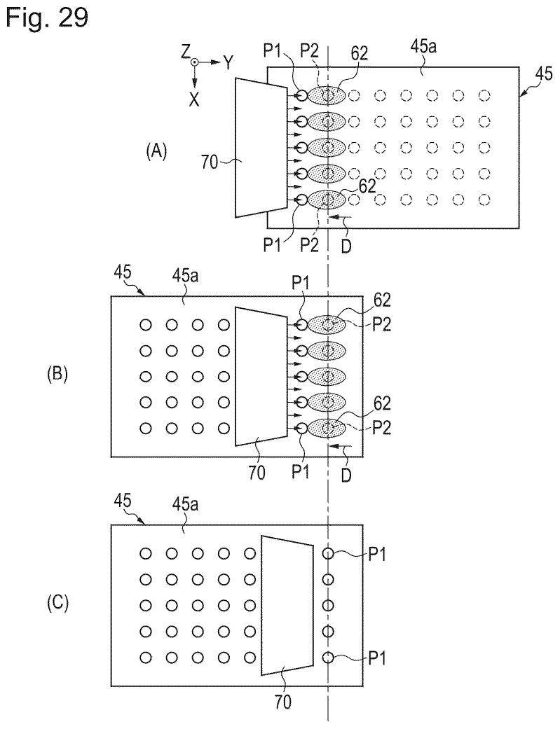

FIG. 29 illustrates a flow of an operation at the time of the laser hole processing according to a modification of the fourth embodiment. FIG. 29 illustrates an example of simultaneously performing the laser hole processing to a plurality of processing positions lined up in the X direction. In the present modification, a multipoint mask 52 in which a plurality of holes are formed is used.

In the present modification, the nozzle 70 is a multi-nozzle, and the nozzle 70 simultaneously ejects the gas to the processing positions P1 during the laser hole processing. The ejecting direction of the gas is opposite to the moving direction D of the workpiece 45. Thus, the product 62 by the laser ablation generated at the processing positions P1 during the laser hole processing is deposited at the next processing positions P2.

In FIGS. 29(A) and 29(B), since the moving direction D of the workpiece 45 is the −Y direction, the laser processing processor 40 sets the ejecting direction of the gas to the +Y direction. The processing positions P1 illustrated in FIG. 29(C) are final processing positions.

In such a manner, by simultaneously performing the laser hole processing to the processing positions, throughput of the laser hole processing is improved.

While the laser hole processing is simultaneously performed to the processing positions arrayed in a row in the present modification, the present invention is not limited thereto, and it is also possible to simultaneously perform the laser hole processing to the processing positions that are two-dimensionally arrayed like 2×5, for example. Further, in order to improve the throughput, it is also preferable that the number of processing positions in the moving direction D of the workpiece 45 be smaller than the number of processing positions in a direction orthogonal to the moving direction D.

### 7. Fifth Embodiment

Next, a laser processing system 1d according to a fifth embodiment will be described. Any component same as that described above is denoted by an identical sign, and redundant description thereof is omitted unless specific description is needed.

### 7.1 Configuration

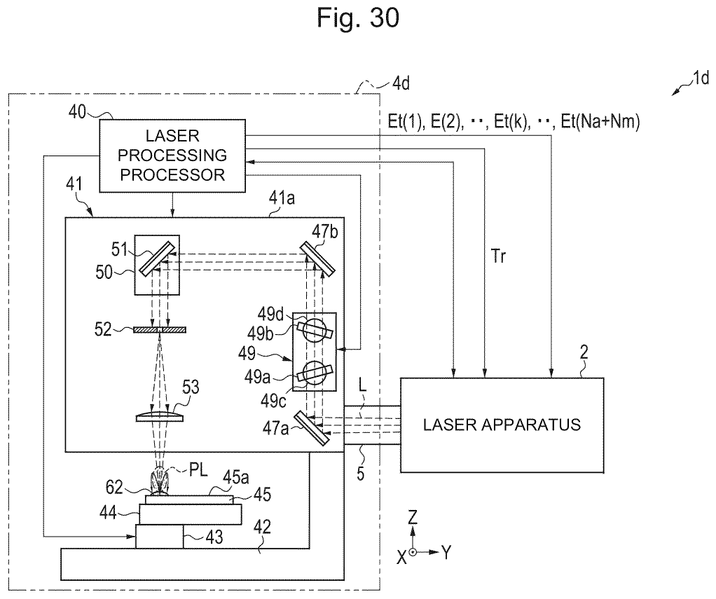

FIG. 30 schematically illustrates a configuration of the laser processing system 1d according to the fifth embodiment. The laser processing system 1d differs from the laser processing system 1b according to the third embodiment in a configuration of a laser processing apparatus 4d. The laser processing apparatus 4d includes a signal line that makes it possible to transmit target pulse energy Et(k) of each of the pulses with which one processing position is irradiated at the time of the laser hole processing to the laser apparatus 2, in addition to the configuration of the laser processing apparatus 4b according to the third embodiment. Here, k is a parameter that identifies the pulses with which one processing position is irradiated.

### 7.2 Operation

Next, an operation of the laser processing system 1d according to the fifth embodiment will be described. In the present embodiment, the setting of a laser ablation region as in the third embodiment is not performed. Further, in the present embodiment, the laser ablation as an operation different from the laser hole processing is not performed. In the present embodiment, the product 62 generated by the laser ablation caused by initial pulses at the time of the laser hole processing is deposited at the processing position under the processing, and the laser hole processing is performed by the subsequent pulses.

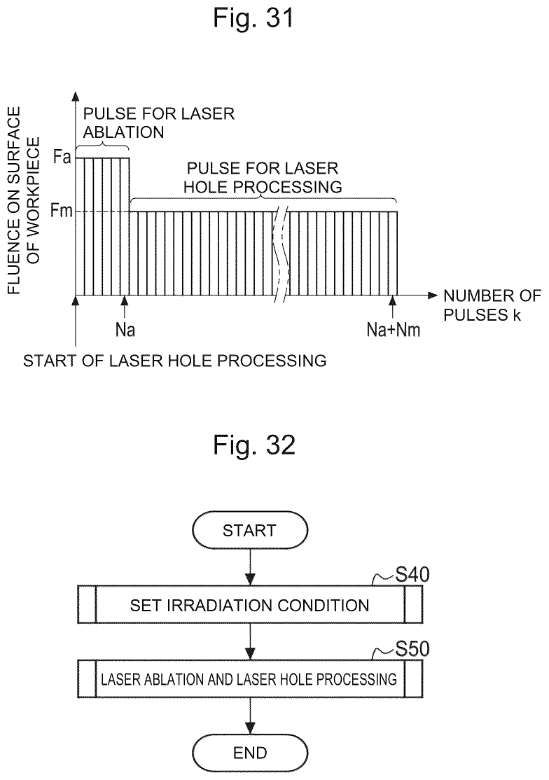

FIG. 31 illustrates a relationship between the fluence Fa of a pulse for the laser ablation and the fluence Fm of a pulse for the laser hole processing. The number of pulses for the laser ablation is Na, and the number of pulses for the laser hole processing is Nm. The laser processing processor 40 sets the fluence Fa sufficient to generate the laser ablation with Na pieces of initial pulses, and irradiates the processing position with the laser beam L. For this purpose, the fluence Fa is preferably greater than the fluence Fm.

In the present embodiment, the first glass substrate and the second glass substrate according to the technology of the present disclosure are both the workpiece 45, and are the same substrate. In the present embodiment, since the fluence of the laser beam L is different between the time of the laser ablation and the time of the laser hole processing, the first irradiation condition and the second irradiation condition are different. The pulse for the laser ablation corresponds to the “first ultraviolet pulse laser beam” according to the technology of the present disclosure. The pulse for the laser hole processing corresponds to the “second ultraviolet pulse laser beam” according to the technology of the present disclosure.

FIG. 32 schematically illustrates a flow of the operation of the laser processing system 1d according to the fifth embodiment. In the present embodiment, the laser processing processor 40 sets the irradiation condition in step S40, and then performs the laser ablation and the laser hole processing to each processing position in step S50.

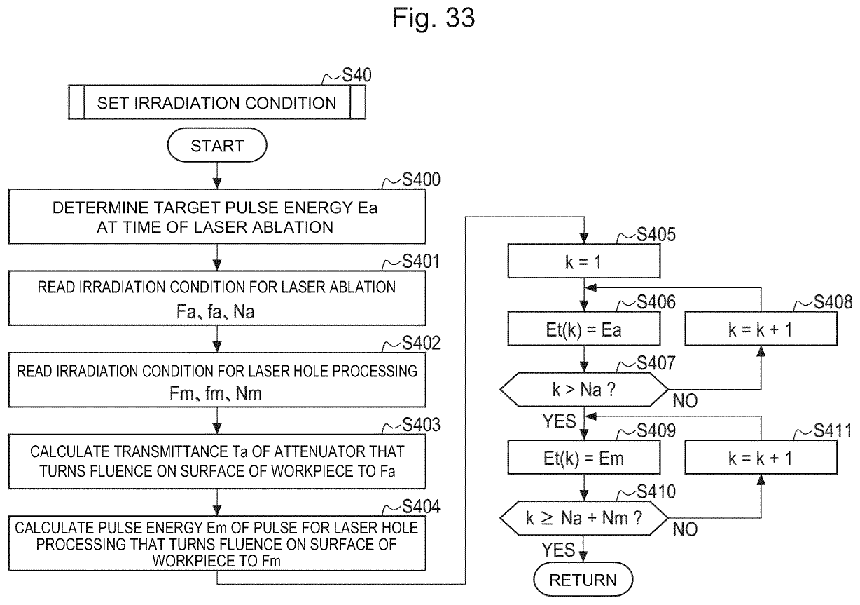

FIG. 33 illustrates a flow of an operation related to setting of the irradiation condition. First, the laser processing processor 40 determines the target pulse energy Ea at the time of the laser ablation (step S400).

The laser processing processor 40 reads the irradiation condition for the laser ablation (step S401). The target fluence Fa, the repetition frequency fa of the pulse of the laser beam L, and the number Na of irradiation pulses are included. Further, the laser processing processor 40 reads the irradiation condition for the laser hole processing (step S402). The target fluence Fm, the repetition frequency fm of the pulse of the laser beam L, and the number Nm of irradiation pulses are included. Here, relations that fa is equal to fm, and Fa is larger than Fm and Na is smaller than Nm are satisfied.

The laser processing processor 40 calculates the transmittance Ta of the attenuator 49 that turns the fluence of the laser beam L on the surface 45a of the workpiece 45 to the target fluence Fa (step S403). Here, the laser processing processor 40 calculates the transmittance Ta using Equation (2) above, for example.

The laser processing processor 40 calculates the pulse energy Em of the pulse for the laser hole processing that turns the fluence of the laser beam L on the surface 45a of the workpiece 45 to Fm (step S404). Here, the laser processing processor 40 calculates the pulse energy Em using Equation (3) below, for example.

Em=(1/T′)×Sm×(Fm/Ta) (3)

Next, the laser processing processor 40 sets target pulse energy Et(1) to Et(Na) of the pulse for the laser ablation to the target pulse energy Ea determined in step S400 (steps S405 to S408). Then, the laser processing processor 40 sets target pulse energy Et(Na+1) to Et(Na+Nm) of the pulse for the laser hole processing to the pulse energy Em calculated in step S404 (steps S409 to S411).

Since the attenuator 49 has low responsiveness to a change in the transmittance, it is difficult to change the transmittance when starting the irradiation with the pulse for the laser hole processing after the irradiation with the pulse for the laser ablation is completed. Therefore, in the present embodiment, the transmittance of the attenuator 49 is fixed to the transmittance Ta calculated based on the fluence Fa for the laser ablation, and the fluence Fm for the laser hole processing is controlled by the pulse energy Em.

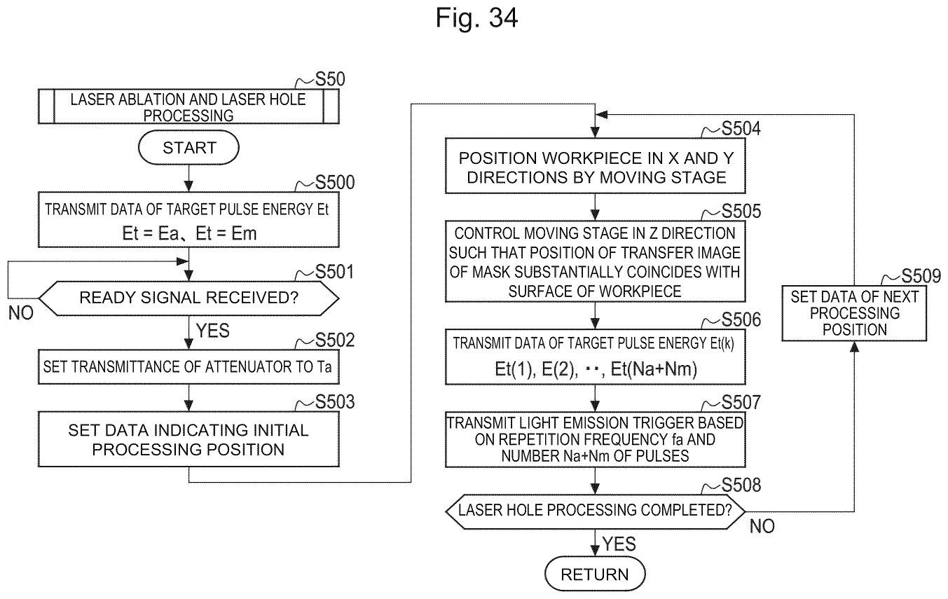

FIG. 34 illustrates a flow of the operation at the time of the ablation and the laser hole processing. First, the laser processing processor 40 transmits data of the target pulse energy Et required for the laser hole processing to the laser apparatus 2 (step S500). Here, the laser processing processor 40 defines that Et is Ea and Et is Em, and transmits the data of Ea and Em to the laser apparatus 2. After receiving the data, the laser apparatus 2 controls the chamber 21, and transmits a ready signal to the laser processing processor 40 when the laser beam L having the target pulse energy Ea and Em can be output.

The laser processing processor 40 determines whether or not the ready signal has been received from the laser apparatus 2 (step S501). When it is determined that the ready signal has been received (step S501: YES), the laser processing processor 40 sets the transmittance of the attenuator 49 to the transmittance Ta calculated in step S40 (step S502).

The laser processing processor 40 sets data indicating an initial processing position in the processing region of the workpiece 45 (step S503). The laser processing processor 40 controls the moving stage 43 based on the set data to position the workpiece 45 in the X and Y directions (step S504). Further, the laser processing processor 40 controls the moving stage 43 in the Z direction such that a position of the transfer image of the mask 52 substantially coincides with the surface 45a of the workpiece 45 (step S505).

The laser processing processor 40 transmits the target pulse energy Et(1) to Et(Na+Nm) set in step S40 to the laser apparatus 2 (step S506). Then, the laser processing processor 40 transmits the light emission trigger Tr to the laser apparatus 2 based on the repetition frequency fa and the number Na+Nm of irradiation pulses (step S507). Consequently, the laser ablation is performed with Na pieces of pulses having the pulse energy Ea to the processing position. Thus, after the product 62 by the laser ablation is deposited at the processing position, the laser hole processing is performed with Nm pieces of pulses having the pulse energy Em.

The laser processing processor 40 determines whether or not the laser hole processing to the processing region has been completed (step S508). The completion of the laser hole processing refers to the completion of the laser hole processing at all the processing positions in the processing region. When it is determined that the laser hole processing has not been completed (step S508: NO), the laser processing processor 40 sets data indicating the next processing position (step S509), and returns the process to step S504.

The laser processing processor 40 repeatedly executes step S504 to step S507 until the laser hole processing is completed. When it is determined that the laser hole processing has been completed (step S508: YES), the laser processing processor 40 ends the processing.

In the present embodiment, the fluence is changed between the pulse for the laser ablation and the pulse for the laser hole processing. Thus, the irradiation with the laser beam L can be performed under the irradiation condition appropriate for depositing the product 62 by the laser ablation at the processing position, and the irradiation with the laser beam L can be performed under the appropriate irradiation condition optimum for the laser hole processing.

Consequently, the cumulative number of irradiation pulses and cumulative energy of the laser beam L can be reduced as compared with a case of the comparative example. Thus, a service life of consumables of the laser processing system 1d can be extended.

### 8. Electronic Device Manufacturing Method

The laser processing method according to the respective embodiments can be applied to formation of a through-hole in a glass substrate included in an interposer 502 in manufacturing of an electronic device 500 described below.

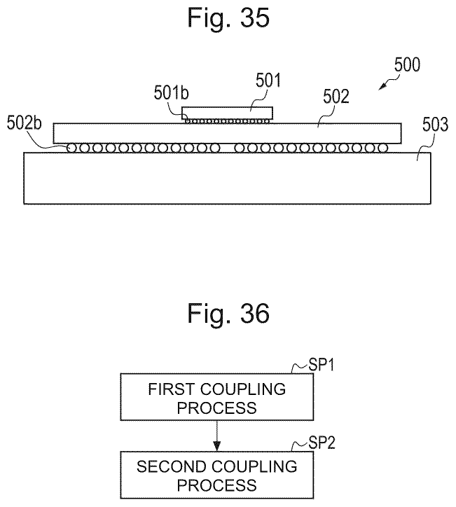

FIG. 35 schematically illustrates a configuration of the electronic device 500. The electronic device 500 illustrated in FIG. 35 includes an integrated circuit chip 501, the interposer 502, and a circuit board 503. The integrated circuit chip 501 is a chip-like integrated circuit board in which an integrated circuit is formed on a silicon substrate, for example. The integrated circuit chip 501 is provided with a plurality of bumps 501b electrically connected to the integrated circuit.

The interposer 502 includes an insulating glass substrate in which a plurality of through-holes are formed, and a conductor that electrically connects front and back of the glass substrate is provided in each through-hole. A plurality of lands connected to the bumps 501b provided on the integrated circuit chip 501 are formed on one surface of the interposer 502, and each land is electrically connected to one of the conductors in the through-holes. A plurality of bumps 502b are provided on the other surface of the interposer 502, and each bump 502b is electrically connected to one of the conductors in the through-holes.

On one surface of the circuit board 503, a plurality of lands connected with the respective bumps 502b are formed. The circuit board 503 includes a plurality of terminals electrically connected to the lands.

FIG. 36 illustrates a manufacturing method of the electronic device 500. As illustrated in FIG. 36, the manufacturing method of the electronic device 500 includes a first coupling process SP1 and a second coupling process SP2. In the first coupling process SP1, the integrated circuit chip 501 and the interposer 502 are coupled. Specifically, the respective bumps 501b of the integrated circuit chip 501 are disposed on the respective lands of the interposer 502 and the bumps 501b and the lands are electrically connected. In this way, the integrated circuit chip 501 and the interposer 502 are electrically connected.

In the second coupling process SP2, the interposer 502 and the circuit board 503 are coupled. Specifically, the respective bumps 502b of the interposer 502 are disposed on the respective lands of the circuit board 503, and the bumps 502b and the lands are electrically connected. In this way, the integrated circuit chip 501 is electrically connected to the circuit board 503 via the interposer 502. Through the processes, the electronic device 500 is manufactured.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser processing method comprising:
depositing a product generated from a first glass substrate at a processing position of a second glass substrate by irradiating the first glass substrate with a first ultraviolet pulse laser beam under a first irradiation condition; and
forming a hole by irradiating the processing position where the product is deposited with a second ultraviolet pulse laser beam under a second irradiation condition different from the first irradiation condition.

2. The laser processing method according to claim 1, wherein
the first irradiation condition and the second irradiation condition include irradiation positions of the first ultraviolet pulse laser beam and the second ultraviolet pulse laser beam, and
the irradiation position of the first ultraviolet pulse laser beam and the irradiation position of the second ultraviolet pulse laser beam are different.

3. The laser processing method according to claim 2, wherein
the first glass substrate and the second glass substrate are different substrates.

4. The laser processing method according to claim 3, wherein
the first ultraviolet pulse laser beam and the second ultraviolet pulse laser beam are ultraviolet pulse laser beams output from a same laser apparatus, and
the first glass substrate and the second glass substrate are irradiated selectively with the first ultraviolet pulse laser beam and the second ultraviolet pulse laser beam.

5. The laser processing method according to claim 2, wherein
the first glass substrate and the second glass substrate are a same substrate.

6. The laser processing method according to claim 5, wherein
the product is deposited at the processing position by irradiating a peripheral part of a processing region including the processing position with the first ultraviolet pulse laser beam.

7. The laser processing method according to claim 5, wherein
the product generated at the processing position is deposited at a next processing position by ejecting a gas toward the processing position.

8. The laser processing method according to claim 1, wherein
the first irradiation condition and the second irradiation condition include at least one of fluence, a repetition frequency, a number of irradiation pulses, and a pulse width.

9. The laser processing method according to claim 8, wherein
the first glass substrate and the second glass substrate are a same substrate,
an irradiation position of the first ultraviolet pulse laser beam and an irradiation position of the second ultraviolet pulse laser beam are a same position, and
the fluence of the first ultraviolet pulse laser beam is larger than the fluence of the second ultraviolet pulse laser beam.

10. The laser processing method according to claim 1, wherein
the first glass substrate and the second glass substrate are alkali-free glass substrates.

11. The laser processing method according to claim 1, wherein
the product is a substance generated by laser ablation.

12. The laser processing method according to claim 1, wherein
the first ultraviolet pulse laser beam and the second ultraviolet pulse laser beam have a same center wavelength.

13. A laser processing apparatus comprising:
an optical device configured to irradiate a first glass substrate and a second glass substrate with an ultraviolet pulse laser beam output from a laser apparatus; and
a laser processing processor configured to control the laser apparatus and the optical device,
the laser processing processor
causing a product generated from the first glass substrate to be deposited at a processing position of the second glass substrate by irradiating the first glass substrate with the ultraviolet pulse laser beam under a first irradiation condition, and
causing the processing position where the product is deposited to be irradiated with the ultraviolet pulse laser beam under a second irradiation condition different from the first irradiation condition.

14. The laser processing apparatus according to claim 13, wherein
the first glass substrate and the second glass substrate are different substrates.

15. The laser processing apparatus according to claim 14, further comprising:
a high reflective mirror; and
a moving mechanism configured to move the high reflective mirror between a position where the high reflective mirror is inserted into an optical path of the ultraviolet pulse laser beam and a position where the high reflective mirror is withdrawn from the optical path.

16. The laser processing apparatus according to claim 15, wherein
the laser processing processor
causes the first glass substrate to be irradiated with the ultraviolet pulse laser beam reflected by the high reflective mirror by inserting the high reflective mirror into the optical path, and
causes the second glass substrate to be irradiated with the ultraviolet pulse laser beam by withdrawing the high reflective mirror from the optical path.

17. The laser processing apparatus according to claim 13, wherein
the first glass substrate and the second glass substrate are a same substrate.

18. The laser processing apparatus according to claim 17, further comprising
a nozzle configured to eject a gas, wherein
the laser processing processor
causes the product generated at the processing position to be deposited at a next processing position by ejecting the gas from the nozzle toward the processing position.

19. An electronic device manufacturing method comprising:
depositing a product generated from a first glass substrate at a processing position of a second glass substrate by irradiating the first glass substrate with a first ultraviolet pulse laser beam under a first irradiation condition;
forming a through-hole by irradiating the processing position where the product is deposited with a second ultraviolet pulse laser beam under a second irradiation condition different from the first irradiation condition;
coupling and electrically connecting an interposer including the second glass substrate and a conductor provided in the through-hole and an integrated circuit chip with each other; and
coupling and electrically connecting the interposer and a circuit board with each other.
